(19) United States
(12) Patent Application Publication
(10) Pub. No.: US 2007/0027773 A1
(43) Pub. Date: Feb. 1, 2007

(54) Method for billing advertiser for keyword advertisement in internet search engine and a system thereof

(76) Inventor: Han Yong Lee, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/541,775

(22) Filed: Oct. 2, 2006

Related U.S. Application Data
(63) Continuation of application No. PCT/KR05/00930, filed on Mar. 31, 2005.

(30) Foreign Application Priority Data
Mar. 31, 2004 (KR) 10-2004-0022119

(51) Int. Cl. G06Q 30/00

(52) U.S. Cl. 705/14

(57) ABSTRACT

Provided is a method for controlling a keyword charge in keyword advertising, including the steps of: dividing an exposure location where a search listing abstracted by predetermined keyword search is displayed into at least one unit display zone; receiving bid price data with respect to display of the search listing in the unit display zone from a predetermined advertiser; as the step of associating a predetermined bid field with the unit display zone in response to receiving of the bid price data, recording the received bid price data in the bid field; sorting at least one bid price data recorded in the bid field on the basis of the size of the unit click cost and giving predetermined rankings to the sorted bid price data, respectively; in response to the keyword search, controlling the search listing of the bid price data at the highest ranking to be exposed in the unit display zone; and as the step of controlling a bill to be charged in accordance with a click selection by a predetermined searcher with respect to the exposed search listing, determining a charge amount generated by the click selection; wherein the charge amount is determined by referring to the unit click cost of predetermined bid price data at a lower ranking, except the bid price data at the highest ranking among the sorted bid price data.

### CROSS-REFERENCE TO RELATED APPLICATIONS

This application is a continuation of International Patent Application No. PCT/KR2005/000930, filed on Mar. 31, 2005, which claims priority to Korean Patent Application No. 10-2004-0022119, filed on Mar. 31, 2004. International Application No. PCT/KR2005/000930 was published in English as WO 2006/004293 on Jan. 12, 2006. Both International Patent Application No. PCT/KR2005/000930 including its publication and Korean Patent Application No. 10-2004-0022119 are incorporated herein by reference in their entirety.

### BACKGROUND

1. Field of the Invention

The present invention relates to advertising on an information network such as the Internet. More particularly, the present invention relates to advertising in reply to a keyword search.

2. Description of the Related Art

Today, an information search through a communication network is being generalized, together with rapid development in the field of communication networks such as the Internet and the like. A user (a searcher) can obtain necessary information easily any time and at any place by using the Internet. In addition, this information search brings our daily lives a lot of changes.

Therefore, there are developed and suggested various models with respect to types for paying advertising costs between an operator and an advertiser. At this time, the operator supports search services for Internet users and the advertiser exposes his/her own information site through a search, thereby obtaining advertising effects.

That is, there are various types for paying advertising costs in search services through a search engine, in accordance with a method for abstracting information of an advertiser, a method for exposing the abstracted advertiser information to a searcher, and a method for charging a bill with respect to the exposed advertiser information, and the like.

As an example of the type for paying advertising costs, there may be a method for predetermining an exposure location on a search screen to display advertiser information, computing a predetermined selling price by each of the predetermined exposure locations and selling the exposure location to the advertiser. This method is a method for giving a right of exposing information to the advertiser who has paid first with respect to the predetermined exposure location not displaying advertiser information. In case that the advertiser wants to expose information on the corresponding exposure location (the particular exposure location where advertiser information is already exposed), the advertiser has to wait until a contract period with respect to the exposed advertiser information is expired. That is, the selling method by exposure locations is a type for paying advertising costs enabling the advertiser to preempt particular exposure locations. Therefore, in case that all the exposure locations are preempted by another advertiser, the advertiser is unable to expose information thereof. In addition, since the selling method is a first-come-first-served method, although the advertiser waits until the contract period ends, it is impossible to guarantee the advertiser exposure of information thereof. Moreover, the selling price is set by a service operator as he/she pleases. Thus, an opinion of the advertiser with respect to the corresponding selling price is never considered.

In addition, as other example of the type for paying advertising costs, there may be a method for exposing advertiser information and determining advertising costs, based on a Cost Per Click (Hereinafter, CPC) method. That is, as the searcher who has requested a search clicks particular advertiser information, the CPC method measures the number of connections (the number of valid connections) between the searcher and the advertiser and computes keyword advertising costs based on the measured number of connections. At this time, the CPC method provides the searcher with search results in which advertiser information of the advertiser who has suggested the highest CPC price (a charge amount per click) is provided in the highest portion and advertiser information of the advertiser who has suggested a lower CPC price is provided in a lower portion. Thus, according to the type for paying advertising costs by the CPC method, it is impossible to guarantee that advertiser information be exposed in the exposure location wanted by the advertiser. That is, advertiser information is sorted sequentially through comparison of the CPC prices suggested by at least one advertiser and exposed on the search screen in accordance with the sorted order. Thus, there is a disadvantage that information may be exposed on the exposure location unwanted by the advertiser. In addition, according to the CPC method, there is a tendency that the advertiser exposes his/her (the company's) search listing in an upper portion of the search screen with a good Click Through Rate (CTR). Thus, there is a contrary effect that keyword advertising costs of advertiser information continue to increase and the advertiser may abandon advertising due to highly priced advertising costs.

In addition, as another example of the type for paying advertising costs, there may be a method for receiving information on a bid price from at least one advertiser during a predetermined period, so as to expose advertiser information on the predetermined exposure location, and giving a right of exposing the same to the advertiser who has suggested the highest bid price. This type for paying advertising costs requires a bidding period for receiving bid prices. Accordingly, it is impossible to appropriately accept demand of the advertiser who wants to register advertiser information rapidly.

Accordingly, there is required the advent of a model for paying advertising costs, capable of charging advertising costs more reasonably and more economically by enabling advertising costs with respect to the exposed search listing to be paid per click of the searcher. In addition, there is required a model for paying advertising costs, capable of exposing advertising rapidly and bringing advertising effect by displaying advertiser information only in the exposure location wanted by the advertiser and performing bidding process in real time at a point when a particular advertiser inputs a bid price.

The foregoing discussion is to provide background information and does not constitute an admission of prior art.

### SUMMARY

One aspect of the invention provides a method for online advertising. The method may comprise receiving a plurality of bids for displaying an advertisement in a predetermined zone of a display screen along with results from a search query elsewhere on the display screen, each bid comprising a maximum payable amount; selecting a first one of the plurality of bids comprising a first maximum payable amount, which is the highest among the maximum payable amounts of the plurality of bids; transmitting signals to a terminal so as to display a first advertisement associated with the first bid in the predetermined zone of a display screen associated with the terminal; and calculating a charge for displaying the first advertisement based on selection of the first advertisement while being displayed in the predetermined zone and further based on a unit charge amount for each selection, which is lower than the first maximum payable amount.

In the foregoing method, the unit charge amount may be the second highest among the maximum payable amounts of the plurality of bids. The unit charge amount may also be greater than the second highest among the maximum payable amounts of the plurality of bids. The unit charge amount may further be greater than a predetermined minimum payable amount. The selection may comprise displaying detailed information of the first advertisement on a display screen associated with a terminal originating a search query. The method may further comprise each of the plurality of bids satisfying predetermined bidding criteria. The predetermined bidding criteria may comprise a requirement that an advertiser submitting a bid must terminate any existing contract for displaying an advertisement in the predetermined zone prior to submitting the bid. The predetermined zone may display a single advertisement, or the predetermined zone may display multiple advertisements. The method may further comprise receiving payment information from an advertiser who submitted the first bid, wherein the payment information comprises information on how to collect payment for the charge from the advertiser; and collecting the charge from the advertiser using the received payment information.

Another aspect of the invention provides a method for online advertising. The method comprises submitting a first bid for displaying an advertisement in a predetermined zone of a display screen along with results from a search query, the first bid comprising a first maximum payable amount; receiving a notice that the first bid is selected from a plurality of bids for displaying an advertisement in the predetermined zone of a display screen along with results from a search query elsewhere on the display screen, each of the plurality of bids comprising a maximum payable amount; and receiving a charge for displaying an advertisement, which is calculated based on selection of the advertisement while being displayed in the predetermined zone and further based on a unit charge amount for each selection, which is lower than the first maximum payable amount.

In the foregoing method, the unit charge amount may be greater than the second highest among the maximum payable amounts of the plurality of bids. The unit charge amount may be a predetermined amount greater than the second highest among the maximum payable amounts of the plurality of bids. The predetermined amount may be a percentage value. The unit charge amount may be a predetermined amount less than the maximum payable amount of the first bid. The method may further comprise displaying on a display screen results of a search query, wherein the advertisement is displayed in the predetermined zone of the display screen.

Yet another aspect of the invention provides a system for online advertising. The system comprises a receiving module configured to receive a plurality of bids for displaying an advertisement in a predetermined zone of a display screen along with results from a search query elsewhere on the display screen, each bid comprising a maximum payable amount; a selection module configure to select a first one of the plurality of bids comprising a first maximum payable amount, which is the highest among the maximum payable amounts of the plurality of bids; a communications module configured to transmit signals to a terminal so as to display a first advertisement associated with the first bid in the predetermined zone of a display screen associated with the terminal; and a calculation module configured to calculate a charge for displaying the first advertisement based on selection of the first advertisement while being displayed in the predetermined zone and further based on a unit charge amount for each selection, which is lower than the first maximum payable amount.

In the foregoing system, the selection module may be further configured to display detailed information of the first advertisement on a display screen associated with a terminal originating a search query.

A further aspect of the invention provides a system for online advertising. The system comprises a bidding module configured to submit a first bid for displaying an advertisement in a predetermined zone of a display screen along with results from a search query, the first bid comprising a first maximum payable amount; a notification module configured to receive a notice that the first bid is selected from a plurality of bids for displaying an advertisement in the predetermined zone of a display screen along with results from a search query elsewhere on the display screen, each of the plurality of bids comprising a maximum payable amount; and a payment module configured to receive a charge for displaying an advertisement, which is calculated based on selection of the advertisement while being displayed in the predetermined zone and further based on a unit charge amount for each selection, which is lower than the first maximum payable amount.

In the foregoing system, the unit charge amount may be greater than the second highest among the maximum payable amounts of the plurality of bids.

### BRIEF DESCRIPTION OF THE DRAWINGS

FIG. 1 is a view illustrating schematic configuration of a system for controlling a keyword charge in keyword advertising according to one embodiment;

FIG. 2 is a configuration diagram illustrating a system for controlling a keyword charge according to an embodiment;

FIG. 3 is a view illustrating one example of a unit display zone constituting an identifiable location and a search listing exposed in the unit display zone;

FIGS. 4 and 5 are views illustrating one example of configuration of a bid field;

FIG. 6 is a flowchart illustrating a method for controlling a keyword charge according to an embodiment;

FIG. 7 is a flowchart illustrating one example of a method for recording bid price data independently in association with a unit display zone and a record area of a bid field;

FIG. 8 is a flowchart illustrating one example of a method for performing bidding process with respect to bid price data;

FIG. 9 is a flowchart illustrating a method for re-performing bidding process in accordance with inputting of new bid price data;

FIG. 10 is a flowchart illustrating a method for performing bidding process with respect to bid price data;

FIG. 11 is a view illustrating one example of a method for determining a charge amount of a search listing displayed in a unit display zone;

FIG. 12 is a flowchart illustrating one example of a method for processing payment with respect to the charge amount;

FIG. 13 is a flowchart illustrating one example of a method for determining a charge amount when there is only one bid price data with respect to a unit display zone; and

FIG. 14 is an internal block diagram of a general purpose computer which can be more employed in implementing a method for controlling a keyword charge.

### DETAILED DESCRIPTION OF EMBODIMENTS

Hereinafter, a method for controlling a keyword charge in keyword advertising and a system thereof will be described with reference to the accompanying drawings.

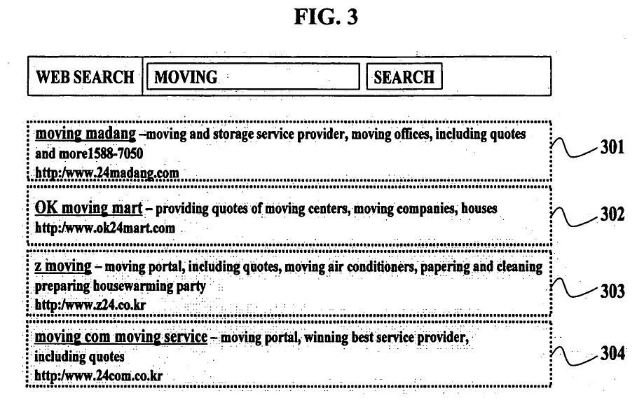

A search listing continuously used in the present specification may be one search result item abstracted in response to a generated search request in such a manner that a predetermined searcher inputs a keyword in a search engine. One search listing may include brief information on an information site operated by an advertiser, i.e., a title of contents, abstract thereof, a network address, and the like. For example, referring to FIG. 3, one search listing abstracted/exposed by the keyword ‘moving’ includes a title of contents, ‘moving madang’, a network address of http://www.24madang.com”, abstract of contents, and the like. Morever, a unit display zone is an independent exposure location for each of search listings abstracted as search results. Particularly, since the unit display zone becomes a target for bidding, a system for controlling a keyword charge receives bid price data of an advertiser to display the search listing in a particular unit display zone. For example, the unit display zone may be associated with locations of search listings outputted when a search word is inputted. A location of the first search listing outputted when the search word is inputted or that of Nth search listing may be the unit display zone. Accordingly, the search listing abstracted by a keyword search is exposed in the particular display zone through predetermined bidding process and provided to the searcher.

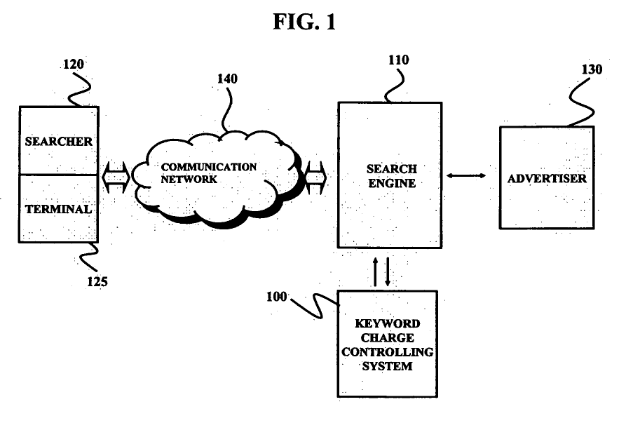

FIG. 1 is a view illustrating schematic configuration of a system for controlling a keyword charge in keyword advertising.

A keyword charge controlling system 100 receives bid price data from an advertiser 130 to display a search listing in a particular unit display zone and determines one search listing to be exposed in the corresponding unit display zone through predetermined bidding process with respect to bid price data.

First, a search engine 110 may be a search program or a search web server supporting searching such that a searcher 120 may access an information site maintaining content materials wanted by the searcher. That is, the search engine 110 serves to reduce time in searching content materials and to improve accuracy of searched materials by providing the searcher 120 with brief information (such as a search listing) on the advertiser 130 who may provide information wanted by the searcher 120, in response to a search request thereof 120. Particularly, since abstracted brief information includes predetermined link information, the searcher 120 may access the particular advertiser 130 in such a manner that the searcher 120 clicks brief information (search listing) displayed in a terminal 125 of the searcher using an instruction input device. When the searcher 120 requests a search, the search listing includes information associated with a web page or a web site which is matched with the search request. In addition, the search listing may include a title of the web page or the web site, a URL, brief description, and the like.

The search engine 110 may be classified into word-oriented searching and subject-oriented searching in accordance with a searching method. According to one aspect, a bill of the corresponding search listing is charged in accordance with a click of the searcher 120 with respect to the particular search listing abstracted/exposed in correspondence to the inputted keyword. In this specification, according to certain embodiments a searching method for the search engine is illustrated with the word-oriented searching method. However, this only for convenience of description and it will be apparent to those skilled in the related art that technical spirits of the present disclosure is not limited thereby.

The searcher 120 may be an internet user who has the terminal 125 for access to the keyword charge controlling system 100 and generates a search request for an information site of the advertiser 130 who maintains content materials that the searcher 120 wants to search, by inputting a predetermined keyword into the search engine 110.

The advertiser 130 is, for example, Contents Providers (CP) who operates an information site whose location is designated on a network by a network address such as an IP address, a URL, a domain, or the like. Therefore, the advertiser 130 pays a predetermined charge amount to the system operator, in accordance with a click of the searcher 120 with respect to the search listing of the information site.

The terminal 125 maintains a connection state with the keyword charge controlling system 100 through a communication network 140, such as the Internet and the like. The terminal 125 displays at least one search listing abstracted by searching of the search engine 110 on a predetermined screen. Like above, the terminal 125 may be a general concept for terminals with a computing function by mounting a predetermined memory means and a predetermined microprocessor, such as for example, personal computers, handheld computers, Personal Digital Assistants, MP3 players, electric dictionaries, cellular phones, smart phones, and the like.

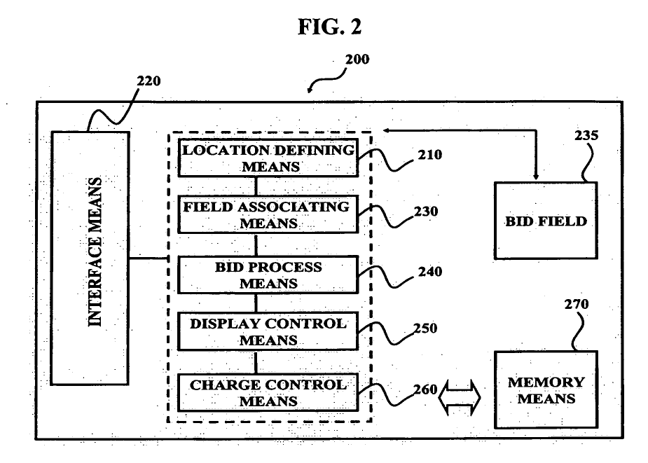

The keyword charge controlling system 100 determines a charge amount in accordance with the number of inputted clicks (the number of clicks) of the searcher 120 with respect to the particular search listing and charges the advertiser 130 of the corresponding search listing the determined charge amount. Particularly, the keyword charge controlling system 100 adopts the aforementioned bidding method in displaying search listings in particular unit display zones, and receives bid price data including a unit click cost such that the advertiser 130 participates into the bid. Through this, the keyword charge controlling system 100 employs a method for computing the charge amount per click of the searcher 120 with respect to the corresponding search listing, in determining the charge amount of the search listing exposed in the unit display zone. Hereinafter, configuration of a keyword charge controlling system 200 will be described with reference to FIG. 2.

FIG. 2 is a configuration diagram illustrating a system for controlling a keyword charge according to one embodiment.

The keyword charge controlling system 200 includes a location defining means 210, an interface means 220, a field associating means 230, a bid process means 240, a display control means 250, a charge control means 260 and a memory means 270. In addition, the keyword charge controlling system 200 further includes a bid field 235 and records at least one bid price data received from the advertiser 1 30 therein 235.

First, the location defining means 210 divides an expose location where a search listing abstracted by predetermined keyword search is displayed into at least one unit display zone. At this time, the location defining means 210 defines the unit display zone by considering an actual Click Through Rate according to a screen arrangement of the searched list order provided to the searcher 120 and a display location thereof (an unit display zone). Why it is necessary to divide the exposure location into unit display zones like above. It is because there is difference in recognition of the searcher 120 with respect to the search listings in accordance with display locations on the screen and there is difference in actual connection probability between the searcher 120 and the advertiser 130 by a click of the searcher 120. Generally, in case of the search listing which is preceded and displayed among a plurality of abstracted search listings, the Click Through Rate (CTR) thereof is high. The location defining means 210 may divide the exposure location into the predetermined number of unit display zones in an upper portion of the search screen where the CTR is high, by considering the CTR. The unit display zone divided by the location defining means 210 may be a location on the search screen, independently exposing at least one portion of the particular search listing among search listings abstracted by keyword search. That is, the unit display zone may be an area where an area occupied by the exposure location is divided in accordance with a predetermined criterion and the divided area is successfully accepted through predetermined bidding process, such as an area exposing one search listing.

The interface means 220 receives bid price data with respect to display of the search listing in the divided unit display zone from the predetermined advertiser 130. At this time, the bid price data includes a unit click cost that the advertiser 1 30 can pay to the maximum. That is, the interface means 220 serves to receive intention of participating into the bid from the advertiser 130 to expose the search listing in the exposure location and, at this time, to receive information on costs per click of the searcher 120 with respect to the corresponding search listing as bid price data to participate into the bid. Particularly, the interface means 220 serves to receive intention of participating into the bid (a selection designating signal) from the advertiser 130 with respect to the unit display zone constituting the exposure location and to transmit bid price data inputted in association therewith to a particular record area of the bid field 235.

The field associating means 230 associates the predetermined bid field 235 with the unit display zone in response to inputting of bid price data and records the inputted bid price data in the bid field 235. At this time, the bid field 235 serves to sort the inputted bid price data, for example, based on the size of the unit click cost and to record the sorted bid price data. Particularly, the bid field 235 records the bid price data in the record area designated by the selection designating signal received from the advertiser 130. That is, the field associating means 230 associates the bid field 235 with the exposure location and, more particularly, associates the record area with each of unit display zones. Moreover, the field associating means 230 records bid price data in the corresponding record area of the unit display zone where the advertiser 130 wants to make a bid.

The bid process means 240 sorts at least one bid price data recorded in the bid field 235 based on the size of the unit click cost and gives predetermined rankings to each of sorted bid price data, respectively. That is, in case that a predetermined bidding condition is satisfied, the bid process means 240 performs bidding process with respect to at least one bid price data recorded in the bid field 235 and gives rankings to each of bid price data in accordance with the size of the unit click cost, respectively. At this time, a higher ranking is given to bid price data with higher unit click cost. Thereby, the bid process means 240 determines bid price data with the highest unit click cost (1st ranking) among bid price data in the bid field 235 as successful price data. At this time, the bidding condition may be that the advertiser 130 inputs new bid price data with respect to the particular unit display zone. The bid process means 240 compares the newly inputted bid price data with bid price data of the search listing which is currently exposed in the corresponding unit display zone and determines bid price data with the higher unit click cost as a successful bidder. Accordingly, there is an effect that it is possible to rapidly determine successful price data through real-time bidding process by inputting of new bid price data and display the corresponding search listing in real time, which will be described later. As an example, new bid price data is inputted as a bidding condition. However, this is one embodiment. For example, in case that a condition for depriving a predetermined exposing right of the currently exposed search listing is satisfied, there may be various bidding conditions enabling bidding process to be performed for remaining bid price data recorded in the record area of the bid field 235. The bidding condition may be flexibly set by the system operator considering system environments.

In addition, the bid process means 240 gives an exposure right to the search listing (a first search listing) of the determined successful price data and enables the first search listing to be displayed in the unit display zone where the advertiser 130 of successful price data participates into the bid. Accordingly, the search listing having the exposure right is displayed in each of unit display zones constituting the exposure location and provided to the searcher 120 who has requested a search as search results.

The display control means 250 controls the search listing of bid price data with the highest ranking to be exposed in the unit display zone, in response to the keyword search of the searcher 120. In addition, the display control means 250 displays the search listing of bid price data at the highest ranking (the highest unit click cost) in the unit display zone in accordance with the sorted order of bid price data in each record area within the bid field 235. That is, the display control means 250 serves to control the first search listing of successful price data (at the first ranking) determined by bidding process to be displayed in the exposure location and to expose the first search listing that is to have the exposure right by bidding process with respect to each of unit display zones.

Hereinafter, bidding process of bid price data and exposing of search listings by a keyword charge controlling system will be described with reference to FIGS. 3 to 5.

FIG. 3 is a view illustrating one example of a unit display zone constituting an identifiable location and a search listing exposed in the unit display zone.

In FIG. 3, it is exemplified that search listings are exposed/abstracted in each of unit display zones 301 to 304 by inputting the keyword ‘moving’ into the predetermined search engine 110. First, the location defining means 210 defines a predetermined area of the search screen where search listings, i.e. search results, are displayed, as an identifiable location 300 and divides unit display zones 301 to 304 for displaying one particular search listing among a plurality of abstracted search listings. In the present embodiment, one of search listings abstracted by the keyword ‘moving’ is exposed in each of four unit display zones 301 to 304, respectively. Accordingly, four search listings are exposed as search results with respect to the keyword ‘moving’. In case that a click selecting signal generates with respect to the exposed search listings by a click of the searcher 120 who has confirmed the above event, the search engine 110 connects the searcher 120 to an information site of the corresponding advertiser 130.

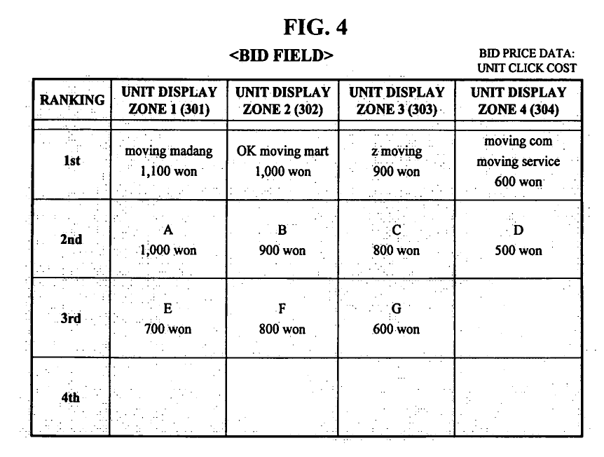

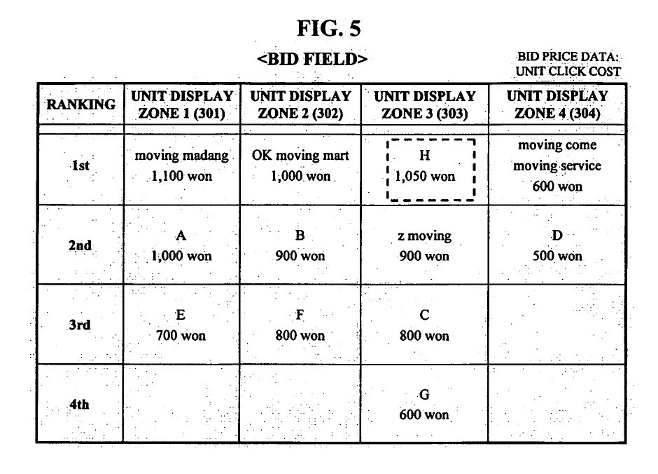

FIGS. 4 and 5 are views illustrating one example of configuration of a bid field. FIG. 4 is a view for explaining bidding process with respect to bid price data recorded in the bid field and FIG. 5 is a view for explaining bidding process by inputting of new bid price data.

As illustrated in FIG. 4, the bid field 235 records the inputted bid price data in accordance with unit display zones 301 to 304. In addition, bid price data within particular unit display zones 301 to 304 are sorted in accordance with the size of the unit click cost included in the bid price data. That is, the keyword charge controlling system 200 recognizes unit display zones 301 to 304 where the advertiser 130 wants to expose the search listing by the received selection designating signal and sorts and records the search listing of the advertiser 130 in the record area designated by the corresponding unit display zones 301 to 304. For example, the advertiser 130 who wants to expose the search listing in the unit display zone 1 301 may generate a selection signal designating the unit display zone 1 301. The field associating means 230 may store bid price data inputted by the advertisers 130 in the record area of the bid field 235 specified as the unit display zone 1 301. At this time, the advertisers 130 are ‘moving madang’, ‘A’ and ‘E’, who have generated the selection designating signal in the unit display zone 1 301. In addition, the bid process means 230 compares unit click costs of bid price data inputted by the advertisers ‘moving madang’, ‘A’ and ‘E’ and sorts bid price data of the advertiser ‘moving madang’ with the highest unit click cost to be at the highest ranking. That is, as illustrated in FIG. 4, bid rice data of the advertiser ‘moving madang’ ranks 1st and rankings are given to bid price data, respectively. Accordingly, the display control means 250 controls the search listing of the advertiser ‘moving madang’ to be displayed in the unit display zone I on the search screen provided to the searcher 120. Search listings to be exposed are determined through the same process in the unit display zones 2 302 to 4 304. At this time, the display control means 250 controls search listings associated with the advertiser ‘OK moving mart’, ‘z moving’, and ‘moving corn moving service’, which are at the highest rankings in each of record areas, to be exposed. Particularly, the keyword charge controlling system 200 may provide the searcher 120 with current state information associated with bid price data recorded in the bid field 235. In addition, the keyword charge controlling system 200 may generate the selection designating signal with respect to particular unit display zones 301 to 304 in accordance with a predetermined click of the searcher 120 who has searched the current state information.

In FIG. 5, it is assumed that the advertiser ‘H’ who has generated a selection designating signal with respect to the unit display zone 3 303 inputs new bid price data of ‘1,050 won’. As aforementioned, a bidding condition to perform bidding process is satisfied by inputting of new bid price data and the bid process means 240 re-sorts bid price data associated with the unit display zone 3 303. As illustrated in FIG. 5, bid price data of the advertiser ‘H’ with the highest unit click cost is successfully accepted. Accordingly, an exposure right with respect to the existing unit display zone 3 303 is transferred from the advertiser ‘z moving’ to the advertiser ‘H’ and the display control means 250 exposes the search listing of the advertiser ‘H’ in the unit display zone 3 303. At this time, bid price data of the advertiser ‘z moving’ is dropped to the next ranking and waits to be exposed. As illustrated in FIG. 5, in the present embodiment, it is exemplified that bid price data ranking 1st place in the unit display zone 3 303 with a comparatively low CTR is larger than the unit click cost of bid price data ranking 1st place in the unit display zone 2 302 with a higher CTR. Through this, it is possible to secure independent bidding process and determining of charge amounts with respect to each of unit display zones 301 to 304.

Bidding process with respect to keyword advertising is performed based on the exposure location (unit display zone). Thus, there is an effect that it is possible to enable the searcher 120 to select a keyword for keyword advertising and also to enable the searcher 120 to select the exposure location of the search listing. In addition, in inputting bid price data associated with display of search listings, a real-time bidding method is adopted based on a cost per click, not an existing first-come-first-served method. Thus, there is an advantage that it is possible to operate reasonable keyword advertising not requiring a waiting period to expose search listings.

Referring to FIG. 2 again, the charge control means 260 may determine a charge amount which is added per click of the searcher 120 with respect to the displayed search listing. Particularly, the keyword charge controlling system 200 determines a charge amount by referring to the unit click cost at the next ranking among bid price data sorted in the record area. At this time, the charge amount is advertising costs with respect to search listings exposed in predetermined unit display zones 302 to 308 and payments added by a click of the searcher 120. Thus, for example, an actual payment with respect to the charge amount may be to subtract the determined charge amount from predetermined deposit money of the corresponding advertiser 130, in interoperation with a click of the searcher 120. In determining the charge amount, the charge control means 260 adds a predetermined additional amount to the unit click cost of bid price data at the next ranking, thereby determining the charge amount.

The additional amount is stored in the memory means 270. The same 270 receives and maintains the additional amount, which is an addition factor, for example, from the system operator. In the present embodiment, the size of the additional amount is not particularly limited, however, in certain embodiments, to appropriately determine the additional amount, such that the charge amount determined in each of unit display zones 301 to 304 does not exceed the unit click cost of bid price data at the highest ranking. This is to determine the unit click cost of bid price data suggested by the advertiser 130 with the intention of paying to the maximum to be smaller than the actually determined charge amount. In addition, in the present embodiment, although the addition factor is exemplified as an additional amount, it is also possible to flexibly use one of four operators and determine the additional amount. Hereinafter, determining of a charge amount using the charge control means 260 will be described with reference to the aforementioned FIG. 4.

In FIG. 4, it is assumed that the unit click cost of bid price data at the next ranking of the bid field 235, which is sorted at the second ranking, is recognized by the charge control means 260 and predetermined additional amount ‘+20’ is added to each of unit click costs. Accordingly, as charge amounts associated with exposing of search listings in each of unit display zones 301 to 304, the charge control means 260 determines the unit display zone 1 301 as ‘1,000+20 won’, the unit display zone 2 302 as ‘900+20 won’, the unit display zone 3 303 as ‘800+20 won’, and the unit display zone 4 304 as ‘500+20 won’. That is, in case that search listings abstracted by inputting of the keyword ‘moving’ of the searcher 120 are associated with the advertisers, ‘moving madang’, ‘OK moving mart’, ‘z moving’, and ‘moving com moving service’, and the searcher 120 clicks the search listing exposed in the unit display zone 1 301 to access ‘moving madang’, the charge control means 260 charges the advertiser 130, who is the advertiser ‘moving madang’, ‘1,020won’.

Accordingly, reasonable payment for a charge amount is enabled by charging the advertiser per click of the searcher 120 with respect to exposed search listings and the advertiser 130 may have more economical and effective advertising effects.

In the present embodiment, it is exemplified that charge amounts for search listings are determined by referring to unit click costs of bid price data at the next rankings. However, this is only for convenience of description. There may be various methods for determining the charge amount, such as a method for determining the unit click cost as the charge amount as it is, for example, by the charge control means 260, and the like.

In addition, in the present embodiment, it is described that advertising costs are charged in accordance with the number of clicks of the searcher 120. However, this is one embodiment. There may be various methods for charging advertising costs, such as for example, the number of exposures of search listings, the number of valid clicks with respect thereto (the number of visits), the number of purchases after access to the advertiser 130, and the like. In addition, advertising costs may be an amount that the advertiser 130 may pay to the maximum in association with the above. Moreover, it is also possible to employ a method for considering the above components in combination. The method for charging advertising costs may be flexibly changed and employed by the system operator considering system environments.

Operation flows of the keyword charge controlling system 200 such configured will be fully described.

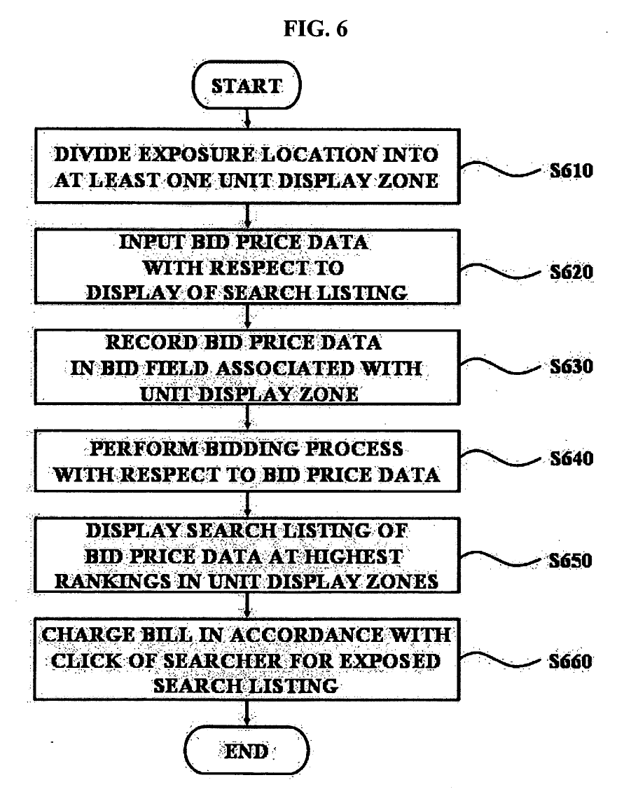

FIG. 6 is a flowchart illustrating a method for controlling a keyword charge according to one embodiment.

The method for controlling a keyword charge according to the present embodiment is performed by the aforementioned keyword charge controlling system 200.

First, the keyword charge controlling system 200 divides the exposure location where search listings abstracted by predetermined keyword search are displayed into one or more unit display zones 301 to 304 (S610). This step S610 is a procedure for determining a location where search listings abstracted in response to inputting of a keyword of the searcher 120 are displayed on the search screen. For example, it is possible to define the highest portion of the search screen as the exposure location by the location defining means 210 based on the CTR. Moreover, in this step S610, the keyword charge controlling system 200 enables the abstracted search listings to be independently exposed by dividing the exposure location into one or more unit display zones 301 to 304. To divide the exposure location into one or more unit display zones 301 to 304 is in order to perform bidding by each of corresponding unit display zones 301 to 304 and expose the particular search listing in the exposure location where the advertiser 130 wants. Through this, it is possible to actively reflect the intention of the advertiser 130.

In addition, the keyword charge controlling system 200 receives bid price data with respect to display of search listings in unit display zones 301 to 304 from the predetermined advertisers 130 (S620). This step S620 is a procedure for receiving bid price data associated with the bid from the advertiser 130 who wants to display his/her (company's) search listing in the particular exposure location. In case that corresponding search listings are abstracted/exposed by searching, each of bid price data includes the unit click cost that the advertiser 130 can pay to the maximum. The unit click cost becomes a kind of a betting value to participate into the bid. The keyword charge controlling system 200 receives a predetermined selection designating signal, which will be described later, from the advertiser 130 to input bid price data with respect to each of unit display zones constituting the exposure location.

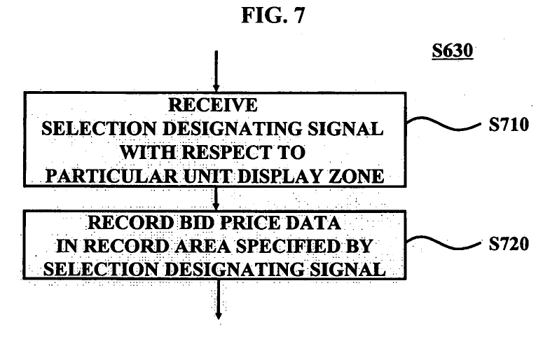

In the next, the keyword charge controlling system 200 associates the predetermined bid field 235 with unit display zones 301 to 304 in response to inputting of bid price data (S630). This step S630 is a procedure for associating the bid field 235 with the particular exposure location where searched list orders are displayed. At this time, the bid field 235 records the received bid price data. Particularly, in this step S630, the keyword charge controlling system 200 may include a procedure of associating each of predetermined record areas with unit display zones constituting the exposure location. Hereinafter, this will be further fully described with reference to FIG. 7.

FIG. 7 is a flowchart illustration one example of a method for recording bid price data independently in association with a unit display zone and a record area of a bid field.

At this time, the bid field 235 may be classified into at least one record area based on unit display zones 301 to 304 and the keyword charge controlling system 200 receives a selection designating signal with respect to a particular unit display zone wanted to display search listings, from the advertiser (S710). At this time, the selection designating signal is to enable unit display zones 301 to 304 where search listings are exposed to be determined by a selection of the advertiser 130. In addition, the selection designating signal serves to designate unit display zones 301 to 304 where bid price data are inputted as betting values. In this step S710, the keyword charge controlling system 200 may record the same bid price data into predetermined record areas where unit display zones 301 to 304, which are targets for bidding, are divided (refer to FIG. 4).

In addition, the keyword charge controlling system 200 records inputted bid price data in record areas of unit display zones 301 to 304 specified by the selection designating signal (S720). This step S720 is a procedure for recognizing unit display zones 301 to 304 that the advertiser 130 makes a bid for and recording bid price data into record areas classified as unit display zones 301 to 304. Accordingly, the keyword charge controlling system 200 independently records bid price data into each of unit display zones 301 to 304 and displays search listings in the wanted exposure location through predetermined bidding process. That is, it is possible to not expose the search listing of the advertiser 130 in the unit display zone unwanted by the advertiser 130.

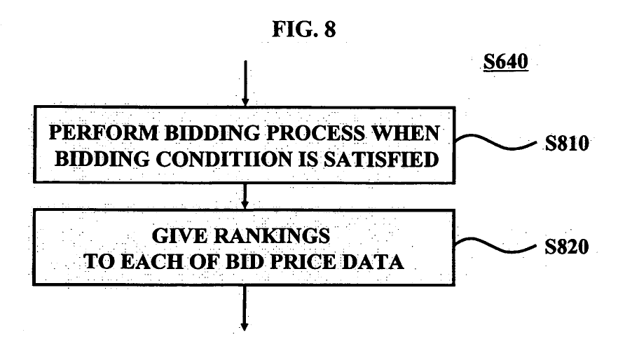

Referring to FIG. 6 again, the keyword charge controlling system 200 sorts at least one bid price data recorded in the bid field 235, based on sizes of unit click costs and gives predetermined rankings to each of sorted bid price data (S640). This step S640 is a procedure for giving the first ranking to bid price data with the highest unit click cost among bid price data recorded in the bid field 235. At this time, bid price data at the first ranking is determined as successful price data. Hereinafter, bidding process will be further fully described with reference to FIGS. 8 to 10.

FIG. 8 is a flowchart illustrating one example of a method for performing bidding process with respect to bid price data.

In FIG. 8, it is exemplified that bid rice data are sorted in record areas by performing bidding process of the bid process means 240.

First, in case that a predetermined bidding condition is satisfied, the keyword charge controlling system 200 performs bidding process with respect to at least one recorded bid price data (S810). This step S810 is a procedure for adjusting rankings of giving an exposure right of each bid price data, such that at least one most suitable bid price data may be selected among bid price data recorded in the bid field 235. In this step S810, the bid process means 240 performs bidding process independently for bid price data with respect to each of unit display zones 301 to 304. At this time, the bidding condition may be a condition to start bidding process of the bid process means 240, for example, inputting of new bid price data, termination of a predetermined display contract with respect to the search listing associated with successful price data, and the like.

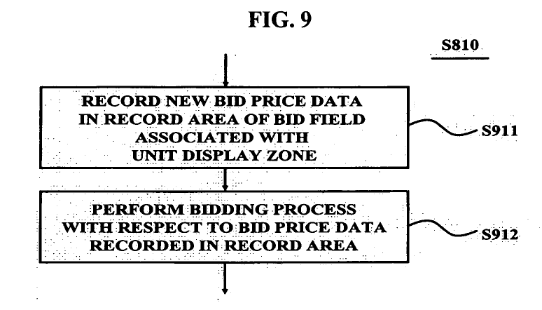

FIG. 9 is a flowchart illustrating a method for re-performing bidding process in accordance with inputting of new bid price data.

As illustrated in FIG. 9, the keyword charge controlling system 200 records new bid price data in the record area of the bid field 235 associated with unit display zones 301 to 304 specified by new bid price data (S911). This step S911 is a procedure for recognizing the unit display zone specified by the selection designating signal and recording the newly inputted bid rice data in the record area in association with the recognized unit display zone. At this time, the selection designating signal is received from the predetermined advertiser 130 who inputs new bid price data.

The keyword charge controlling system 200 performs bidding process with respect to at least one bid price data recorded in the record area, including new bid price data (S912). This step S912 is a procedure for re-sorting bid price data through comparison bewtween the size of the unit click cost of new bid rice data and that of previously recorded bid price data. For example, as illustrated in FIG. 5, in case that the unit click cost of new bid price data inputted by the advertiser ‘H’ is higher than the unit click cost associated with the advertiser ‘z moving’ exposed in the unit display zone 3 303, bid price data are re-sorted by the bid process means 240, such that new bid price data ranks I st.

Accordingly, in case that the advertiser 130 inputs new bid price data whose unit click cost is higher than that of the search listing exposed in the predetermined unit display zone, there is an effect that it is possible to expose search listings in real time.

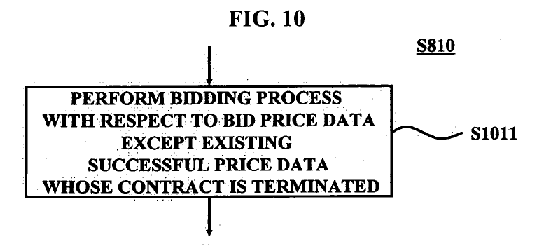

In addition, in the step S810, the bidding condition may be termination of the predetermined contract associated with the search listing displayed in the unit display zone. Hereinafter, bidding process by termination of the contract will be described with reference to FIG. 10.

At this time, termination of the contract is when it is impossible to continuously expose the search listing of bid price data maintaining an exposure right (a right to display the search listing in a predetermined unit display zone) due to stopping of search word advertising of the advertiser 130, disappearing of predetermined deposit money for advertising or the like.

FIG. 10 is a flowchart illustrating a method for re-performing bidding process with respect to bid price data by termination of a contract of the exposed search listing.

As illustrated in FIG. 10, the keyword charge controlling system 200 performs bidding process with respect to at least one recorded bid price data, except corresponding bid price data of the search listing whose contract is terminated (S1011). This step S1011 is a procedure for removing existing 1st ranked bid price data (successful price data) whose contract is terminated from the record area of the bid field 235 and performing bidding processs with respect to bid price data raking 2nd or lower. Therefore, the keyword charge controlling system 200 transfers the exposure right to existing bid price data ranking 2nd and exposes the corresponding search listing in the unit display zone.

Accordingly, in case that the exposure right for the currently exposed search listing is terminated, the search lit order is able to be exposed in the unit display zone by bid price data at the next ranking waiting to be exposed, to be continuously exposed. Thus, there an effect that it is possible to bring advertising benefits to the system operator continuously.

Referring to FIG. 8 again, the keyword charge controlling system 200 gives rankings to each of bid price data by bidding process (S820). This step S820 is a procedure for giving rankings to bid price data by each of unit display zones in order to determine bid price data of the search listings displayable in unit display zones 301 to 304, i.e., in order to determine successful price data. For example, the 1 st ranking is given to bid price data with the highest unit click cost and the lowest ranking is given to bid price data with the lowest unit click cost. That is, a higher ranking is given to bid price data with a higher unit click cost. Accordingly, the keyword charge controlling system 200 determines bid price data with the highest unit click cost (1st ranking) among bid price data recorded in the bid field 235 as successful bid price data. For example, in the aforementioned FIG. 4, the keyword charge controlling system 200 may determine bid price data at the highest rankings (1st ranking) in each of unit display zones 301 to 304 as successful price data.

Accordingly, search listings exposed in each of unit display zones are determined by receiving bid price data associated with unit click costs from advertisers 130 and comparing the received bid price data. Thus, it is more reasonable than a method for determining search listings by using the existing first-come-first-served method. In addition, there is an effect that it is possible to least offend the advertiser 130 who is not successfully accepted.

Referring to FIG. 6 again, the keyword charge controlling system 200 controls search listings of bid price data at the highest rankings to be exposed in the unit display zones 301 to 304, in response to the keyword search (S650). This step S650 is a procedure for exposing search listings of bid price data determined as successful price data by bidding process in corresponding unit display zones. The exposure right is given to bid price data with the highest unit click cost.

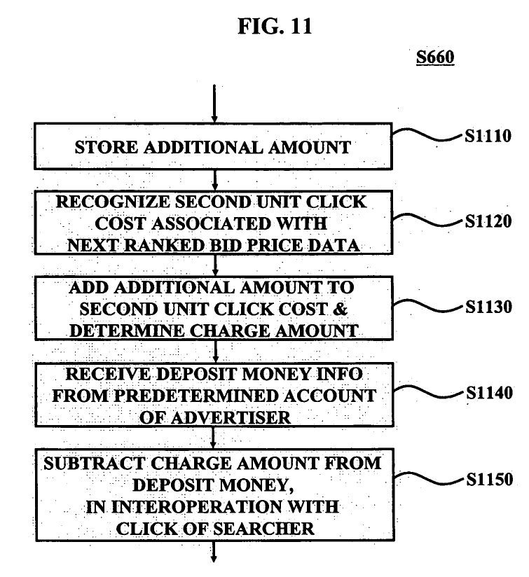

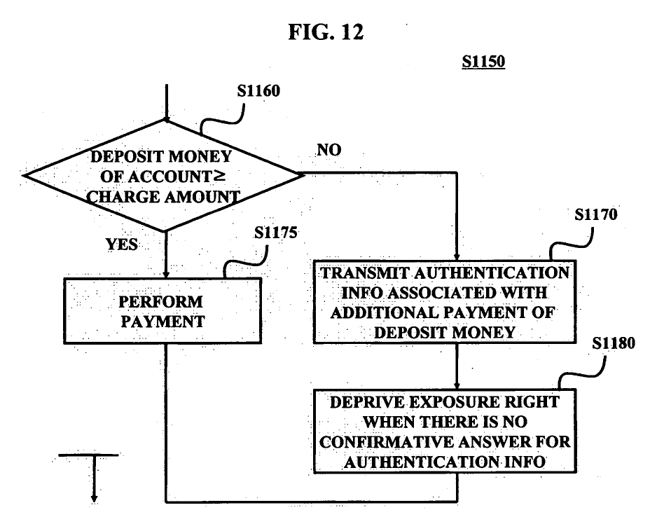

In addition, the keyword charge controlling system 200 controls a bill to be charged in accordance with a click of the searcher 120 with respect to exposed search listings (S660). This step S660 is a procedure for determining a charge amount generated by the click of the searcher 120 with respect to search listings exposed in unit display zones 301 to 304. The charge amount is determined by referring to the unit click cost at the next ranking among the sorted bid price data. That is, in the present embodiment, the charge amount is not determined by the unit click cost inputted as bid price data by the advertiser 130 associated with the exposed search listing, but determined by referring to the unit click cost ranking 2nd place. Hereinafter, determining of the charge amount and settling thereof will be further fully described with reference to FIGS. 11 and 12.

FIG. 11 is a view illustrating one example of a method for determining a charge amount of a search listing displayed in a unit display zone.

First, the keyword charge controlling system 200 maintains the memory means 270 storing an additional amount determined by a predetermined criterion (S1110). This step S1110 is a procedure for storing/maintaining an additional amount of an addition factor, which is a component in determining a charge amount, in the memory means 270. The additional amount may be flexibly set by the system operator considering system environments. That is, the additional amount may be appropriately set, such that the charge amount determined in each of unit display zones 301 to 304 may not exceed the unit click cost of bid price data at the highest ranking.

In addition, the keyword charge controlling system 200 recognizes a second unit click cost associated with bid price data at the next ranking in the record area (S1120). This step S1120 is a procedure for identifying the unit click cost of bid price data ranking 2nd place, which is the second unit click cost. For example, in FIG. 4, second unit click costs are ‘1,000 won’ in the unit display zone 1 301, ‘900 won’ in the unit display zone 2 302’, ‘800 won’ in the unit display zone 3 303 and ‘500 won’ in the unit display zone 4 304.

In the next, the keyword charge controlling system 200 adds the additional amount to the second unit click cost and determines the charge amount (S1130). This step S1130 is a procedure for determining the charge amount of the search listing associated with bid price data having a predetermined exposure right by using a computing method of ‘second unit click cost +additional amount’. That is, the keyword charge controlling system 200 displays search listings associated with bid price data at the first rankings in unit display zones 301 to 304 and determines charge amounts for the advertisers 130 in accordance with the click of the searcher 120 with respect to the search listings.

Accordingly, the advertiser 130 is charged for the search listing per click of the searcher 120. At this time, the charge amount is determined to be smaller than the unit click cost inputted by the corresponding advertiser 130 to participate in the bid. Thus, there is an effect that it is possible to compute economical and reasonable keyword advertising costs.

In addition, the keyword charge controlling system 200 may pay an amount corresponding to the charge amount from a predetermined account of the advertiser 130, as keyword advertising costs.

For this, the keyword charge controlling system 200 receives deposit money information from an account of the advertiser 130 associated with the exposed search listing (S1140). In this step S1140, the keyword charge controlling system 200 recognizes information on a predetermined reserve fund inputted by the advertiser 130 to display the particular search listing in the exposure location. For example, the keyword charge controlling system 200 confirms deposit money remaining in the account of the advertiser 130 at the point where the searcher 120 clicks the exposed search listing. In the present embodiment, the time of paying deposit money and an initial amount of deposit money are not exactly limited. However, for example, it is possible to provide the advertiser 130 with information on deposit money adjusted based on a charge amount of the previous period or statistical information on the number of clicks, an inclination in the number of the latest clicks, a varied numerical value in the number of season-oriented exposures/clicks, and the like, at a point where the exposure right with respect to the corresponding search listing is give. In addition, it is also possible to induce adjusted deposit money to be received from the advertiser 130.

In the next, the keyword charge controlling system 200 subtracts the determined charge amount from deposit money, in interoperation with a click of the searcher 120 (S1150). This step S1150 is a procedure for processing payment of the corresponding charge amount per click of the searcher 120 with respect to the search listing. Through this, payment for the charge amount is enabled using the Cost Per Click (CPC) method and it is possible to compute more reasonable keyword advertising costs. In addition, this step S1150 may further include the step of determining whether to continue to expose the corresponding search listing as remaining deposit money decreases from an account of the advertiser 130. This will be described with reference to FIG. 12.

FIG. 12 is a flowchart illustrating one example of a method for processing payment with respect to a charge amount.

As illustrated in FIG. 12, the keyword charge controlling system 200 compares the charge amount with deposit money of an account (SI 160). This step S1160 is a procedure for determining whether the charge amount to be paid in correspondence to a click of the searcher 120 remains in deposit money. For example, the balance of deposit money currently remaining in an account of the advertiser 130 is confirmed by the charge control means 260.

In case that deposit money is determined to be smaller than the charge amount (No direction), the keyword charge controlling system 200 transmits authentication information associated with additional payment of deposit money to the advertiser 130 (S1170). This step S1170 is a procedure for providing the advertiser 130 of the corresponding search listing with information on unperformed payment caused by short of the balance of deposit money and transmitting authentication information to induce re-payment of deposit money with respect to the account.

In case that there is no confirmative answer from the advertiser with respect to authentication information until a predetermined time elapses, the keyword charge controlling system 200 controls the predetermined exposure right to be deprived with respect to the exposed search listing (S1180). In this step S1180, in case that there is no answer for adding of deposit money until a certain time elapses after authentication information is transmitted to the advertiser 130 (or in case that there is a rejecting answer for adding of deposit money), it is recognized that the advertiser 130 has no intention of exposing the search listing and the advertiser 130 is deprived of the exposure right in unit display zones 301 to 304. Accordingly, re-bidding is performed by the bidding process means 240. For example, the exposure right is transmitted to bid price data waiting to be exposed at the next ranking and search listings are exposed in unit display zones 301 to 304.

On the other hand, in case that it is determined that deposit money remains more than charge amount (yes direction), the keyword charge controlling system 200 performs payment by subtracting the charge amount from deposit money (S 1175).

Accordingly, it is possible to notify the advertiser 130 of information on short of the balance of deposit money associated with payment. In addition, it is also possible to provide the advertiser 130 with the opportunity to pay an additional amount with respect to deposit money. Thus, there is an effect that it is possible not to generate a well-intentioned damage.

In the present embodiment, it is described that authentication information is provided to the advertiser 130 when deposit money is less than the charge amount. Besides, there may be various methods of providing authentication information such as a method for generating authentication information at a point where the balance of deposit money is less than an amount set by the system operator.

As for another embodiment, it will be described that there is no bid price data for the next ranking in determining the charge amount with respect to successful price data.

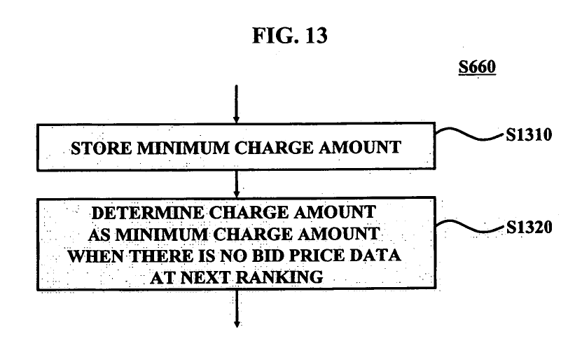

FIG. 13 is a flowchart illustrating one example of a method for determining a charge amount when there is one bid price data with respect to a unit display zone.

First, the keyword charge controlling system 200 maintains the memory means 270 for storing a predetermined minimum charge amount (S1310). This step S1310 is a procedure for storing information on the minimum charge amount with respect to the search listing. At this time, the minimum charge amount may be flexibly set by the system operator.

In the next, in case that there is no bid price data at the next ranking, the keyword charge controlling system 200 determines the charge amount as the minimum charge among (S1320). This step S1320 is a procedure for determining the charge amount in case that bid price data participating into the bid for particular unit display zones 301 to 304 is received from one advertiser 130. That is, exceptionally from the aforementioned method for determining the charge amount, the charge amount determined in this step S1320 becomes the minimum charge amount which is already set/maintained in the memory means 270 due to absence of bid price data at the next ranking.

Accordingly, although there is one bid price data participating into the bid for unit zones 301 to 304, it is easy to determine the charge amount with respect to the exposed search listing. Also, there is an effect that it is possible to bring minimum advertising benefits to the system operator.

In the present embodiment, it is exemplified that the already set minimum charge amount is determined as the charge amount of the search listing. However, this is one embodiment. There may be various methods for determining the charge amount, such as a method for determining the unit click cost inputted by the advertiser 130 as the charge amount, and the like.

Certain embodiments include computer readable media including program instructions to implement various operations embodied by a computer. The media may also include, alone or in combination with the program instructions, data files, data structures, tables, and the like. The media and program instructions may be those specially designed and constructed for certain embodiments disclosed herein, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and harware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

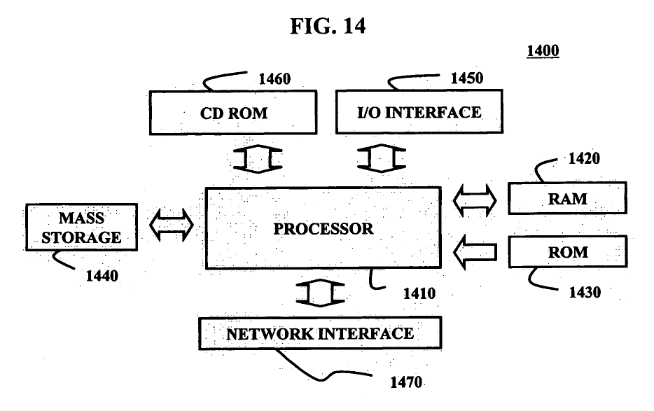

FIG. 14 is an internal block diagram of a general-purpose computer which can be more adopted in implementing the method for controlling a keyword charge.

The computer system 1400 includes any number of processors 1410 (also referred to as central processing units, or CPUs) that are coupled to storage devices including primary storage (typically a random access memory, or “RAM 1420 ”), primary storage (typically a read only memory, or “ROM 1430”). As is well known in the art, ROM 1430 acts to transfer data and instructions uni-directionally to the CPU and RAM 1420 is used typically to transfer data and instructions in a bi-directional manner. Both of these primary storage devices may include any suitable type of the computer-readable media described above. A mass storage 1440 is also coupled bi-directionally to CPU and provides additional data storage capacity and may include any of the computer-readable media described above. The mass storage device 1440 may be used to store programs, data and the like and is typically a secondary storage medium such as a hard disk that is slower than primary storage. A specific mass storage device such as a CD-ROM 1460 may also pass data uni-directionally to the CPU. Processor 1410 is also coupled to an interface 1450 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 1410 optionally may be coupled to a computer or telecommunications network using a network connection as shown generally at a network interface 1470. With such a network connection, it is contemplated that the CPU might receive information from the network, or might output information to the network in the course of performing the above-described method steps. The above-described devices and materials will be familiar to those of skill in the computer hardware and software arts.

The hardware elements above may be configured to act as one or more software modules for implementing the operations of certain embodiments discussed herein.

The foregoing descriptions of specific embodiments have been presented for purposes of illustration and description. They are not intended to be exhaustive or to limit the invention to the precise forms disclosed, and obviously many modifications and variations are possible in light of the above teaching.

Therefore, it is intended that the scope of the invention be defined by the claims appended thereto and their equivalents.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

### INDUSTRIAL APPLICABILITY

Provided herein are methods for controlling a keyword charge and a system thereof, which can compute economical and reasonable keyword advertising costs by charging an advertiser a charge amount with respect to search listings per click and, at this time, determining the charge amount to be smaller than a unit click cost inputted by the advertiser to participate into a bid.

Also provided herein are methods for controlling a keyword charge and a system thereof, which can generate advertising effects that an advertiser wants by displaying search listing, which are search results, in an exposure location wanted by the advertiser, through inputting of a predetermined bid price and bidding process.

Also provided herein are methods for controlling a keyword charge and a system thereof, which can determine display of a search listing in a particular exposure location by a bid and, at this time, expose the search listing without a bid waiting period through inputting of appropriate bid price data.

Also provided herein are methods for controlling a keyword charge and a system thereof, which enable reasonable bidding process by including a unit click cost in bid price data and determine successful price data through comparison between sizes of unit click costs, in which the unit click cost is an amount that an advertiser can pay to the maximum.

What is claimed is:

1. A method for online advertising, the method comprising:
receiving a plurality of bids for displaying an advertisement in a predetermined zone of a display screen along with results from a search query elsewhere on the display screen, each bid comprising a maximum payable amount;
selecting a first one of the plurality of bids comprising a first maximum payable amount, which is the highest among the maximum payable amounts of the plurality of bids;
transmitting signals to a terminal so as to display a first advertisement associated with the first bid in the predetermined zone of a display screen associated with the terminal; and
calculating a charge for displaying the first advertisement based on selection of the first advertisement while being displayed in the predetermined zone and further based on a unit charge amount for each selection, which is lower than the first maximum payable amount.

2. The method of claim 1, wherein the unit charge amount is the second highest among the maximum payable amounts of the plurality of bids.

3. The method of claim 1, wherein the unit charge amount is greater than the second highest among the maximum payable amounts of the plurality of bids.

4. The method of claim 1, wherein the unit charge amount is greater than a predetermined minimum payable amount.

5. The method of claim 1, wherein the selection comprises displaying detailed information of the first advertisement on a display screen associated with a terminal originating a search query.

6. The method of claim 1, wherein each of the plurality of bids satisfies predetermined bidding criteria.

7. The method of claim 6, wherein the predetermined bidding criteria comprises a requirement that an advertiser submitting a bid must terminate any existing contract for displaying an advertisement in the predetermined zone prior to submitting the bid.

8. The method of claim 1, wherein the predetermined zone displays a single advertisement.

9. The method of claim 1, wherein the predetermined zone can display multiple advertisements.

10. The method of claim 1, further comprising:
receiving payment information from an advertiser who submitted the first bid, wherein the payment information comprises information on how to collect payment for the charge from the advertiser; and
collecting the charge from the advertiser using the received payment information.

11. A method for online advertising, the method comprising:
submitting a first bid for displaying an advertisement in a predetermined zone of a display screen along with results from a search query, the first bid comprising a first maximum payable amount;
receiving a notice that the first bid is selected from a plurality of bids for displaying an advertisement in the predetermined zone of a display screen along with results from a search query elsewhere on the display screen, each of the plurality of bids comprising a maximum payable amount; and
receiving a charge for displaying an advertisement, which is calculated based on selection of the advertisement while being displayed in the predetermined zone and further based on a unit charge amount for each selection, which is lower than the first maximum payable amount.

12. The method of claim 11, wherein the unit charge amount is greater than the second highest among the maximum payable amounts of the plurality of bids.

13. The method of claim 11, wherein the unit charge amount is a predetermined amount greater than the second highest among the maximum payable amounts of the plurality of bids.

14. The method of claim 13, wherein the predetermined amount is a percentage value.

15. The method of claim 11, wherein the unit charge amount is a predetermined amount less than the maximum payable amount of the first bid.

16. The method of claim 11, further comprising: displaying on a display screen results of a search query, wherein the advertisement is displayed in the predetermined zone of the display screen.

17. A system for online advertising comprising:
a receiving module configured to receive a plurality of bids for displaying an advertisement in a predetermined zone of a display screen along with results from a search query elsewhere on the display screen, each bid comprising a maximum payable amount;
a selection module configure to select a first one of the plurality of bids comprising a first maximum payable amount, which is the highest among the maximum payable amounts of the plurality of bids;
a communications module configured to transmit signals to a terminal so as to display a first advertisement associated with the first bid in the predetermined zone of a display screen associated with the terminal; and
a calculation module configured to calculate a charge for displaying the first advertisement based on selection of the first advertisement while being displayed in the predetermined zone and further based on a unit charge amount for each selection, which is lower than the first maximum payable amount.

18. The system of claim 17, wherein the selection module is further configured to display detailed information of the first advertisement on a display screen associated with a terminal originating a search query.

19. A system for online advertising comprising:
a bidding module configured to submit a first bid for displaying an advertisement in a predetermined zone of a display screen along with results from a search query, the first bid comprising a first maximum payable amount;
a notification module configured to receive a notice that the first bid is selected from a plurality of bids for displaying an advertisement in the predetermined zone of a display screen along with results from a search query elsewhere on the display screen, each of the plurality of bids comprising a maximum payable amount; and
a payment module configured to receive a charge for displaying an advertisement, which is calculated based on selection of the advertisement while being displayed in the predetermined zone and further based on a unit charge amount for each selection, which is lower than the first maximum payable amount.

20. The system of claim 19, wherein the unit charge amount is greater than the second highest among the maximum payable amounts of the plurality of bids.
